(19) United States
(12) Patent Application Publication
(10) Pub. No.: US 2004/0149186 A1
(43) Pub. Date: Aug. 5, 2004

(54) Implement for cultivating and depositing material in soil

(76) Inventors: Crister Stark, Vaderstad (SE); Gustav Edholm, Vikingstad (SE)

Correspondence Address: NIXON & VANDERHYE, PC, 1100 N GLEBE ROAD, 8TH FLOOR, ARLINGTON, VA, 22201-4714, US

(21) Appl. No.: 10/437,191

(22) Filed: May 14, 2003

(30) Foreign Application Priority Data
Nov. 22, 2002 (SE) 0203481-7

(51) Int. Cl. A01C 5/00

(52) U.S. Cl. 111/25

(57) ABSTRACT

An implement for an agricultural machine includes a plurality of discs arranged to create furrows and a plurality of dispensers designed to provide at least first and second depositing locations. The first depositing location lies at a height close to the lowest point of the disc to enable deposition of material at the bottom of a furrow. The second depositing location is located such that the material is deposited into or onto the top of a soil flow created by the discs.

This invention relates to an agricultural implement for forming furrows and depositing materials such as seeds, fertilizers and the like at selected depths into or on the prepared soil.

### BACKGROUND OF THE INVENTION

Agricultural implements of various sizes and designs have been on the market for many years. Traditionally, these implements have involved a number of working steps, e.g., plowing, cultivating or other soil preparation and, finally, dispensing or depositing seed, fertilizer and the like (hereafter referred to as material) into or onto prepared soil. During recent years, the desire to cultivate and plant in more or less unprepared ground has grown stronger. This would, of course, represent savings in time, fuel and wear and would include preparation and planting directly in stubble and trash or soil preparation by a machine with cultivator tines or discs for penetrating straw and surface residue, mixed trash and soil, to create an even surface and depositing material into or on the prepared surface. This imposes great demands on the agricultural implement, which would have to accomplish a fairly level and consolidated surface and, at the same time, place the material at a fairly exact predetermined depth. This should preferably also be achieved at fairly high speeds of up to 20 km/h.

There are certain machines of this type on the market equipped with so-called “One-Way-Disc-Systems.” In systems of that type, discs create furrows into which seed is deposited and adjacent discs, located slightly behind and to the side create new furrows and, at the same time, create soil flows that close the first furrows. These machines have disadvantages, such as only one row of tools, problems in keeping a straight direction of travel and having requirements for use in the same travel direction over the entire field. Also, a new machine type designed for intensive shallow cultivation with discs or tines, followed by roller units, resulting in a smooth surface has grown more popular with farmers. These machines are, however, usually not designed for depositing material into or on the prepared soil.

### BRIEF DESCRIPTION OF THE INVENTION

In accordance with a preferred embodiment of the present invention, there is provided an agricultural implement for use with an agricultural machine with cultivator tools for the purpose of depositing material at a depth that may be different relative to the depth of the furrows created by the cultivating tools. Particularly, there is provided an agricultural implement having a plurality of discs arranged to create furrows, in combination with a plurality of dispensers including dispensing nozzles for depositing material at two discrete depositing locations, where only one location at a time is used such that a depositing location may be located for depositing material at the bottom of a furrow or at a second depositing location located for depositing material into or on top of a soil flow created by the discs. Consequently, by having a second depositing location located so that material is deposited into or on top of the soil flow created by the discs, it is possible to ensure that the material ends up close to the surface, even if the discs are working at greater depths. For example, a first depositing location may be used for grain which requires working with discs creating fairly shallow furrows. The second depositing location may then be used for catch crops such as grass or other crops, which need to be placed in shallow soil but the implement affords the choice of deeper cultivation for soil preparation depending on soil conditions and the possibility of future crops. In a preferred embodiment of the present agricultural implement, the implement with the dispensing nozzles arranged to dispense material at alternate depths may be provided with two rows of cultivated discs followed by rollers. Thus, intense shallow cultivation with level and consolidated soil surfaces may be achieved with deeper soil preparation if desired. Preferably, the number of discs and depositing nozzles are equal to one another. While this enables maximum efficiency, an alternative is to fit the dispensing nozzles with selected discs rather than each disc. Preferably, the discs are also individually and resiliently suspended from an implement frame and at an angle to the direction of travel to not only create a furrow efficiently but also to enhance the ability of the implement to withstand mechanical stress.

In a specific embodiment, each dispensing nozzle is mounted for axial movement on a conduit connected with a material feeder. This arrangement enables adjustment of the dispensing nozzle and, hence, the depositing locations. It also enables adjustment of the nozzle so that the nozzle outlet can be maintained at a fixed position relative to the disc, notwithstanding disc wear. The dispensing nozzle may also be formed of a rubber or other elastic material to better withstand mechanical stress. Further, and in another embodiment, the dispensing nozzle can be rotated about its mounting, enabling quick change between outlet positions without the need for complex tools.

In a preferred embodiment according to the present invention, there is provided an agricultural implement comprising a plurality of discs arranged to create furrows, a plurality of dispensers for depositing material, each dispenser being movable to provide at least first and second discrete depositing locations whereby only one location at a time may be used, the first depositing location being at a location for depositing the material at the bottom of a furrow and the second depositing location being located for depositing the material into or on top of a soil flow created by one or more of the plurality of discs.

### BRIEF DESCRIPTION OF THE DRAWINGS

FIG. 1 is a perspective view of an agricultural implement according to a preferred embodiment of the present invention;

FIG. 2 is a side elevational view of the implement with the dispensing nozzles in a first position;

FIG. 3 is a view similar to FIG. 2 with the dispensing nozzles in a second position;

FIG. 4 is a side elevational view similar to FIG. 2 illustrating an alternate embodiment of the dispensing nozzles;

FIG. 5 is a view similar to FIG. 4 illustrating the dispensing nozzle of FIG. 4 in a second position;

FIG. 6 is a side elevational view of a further alternative embodiment with the dispensing nozzle in a first position;

FIG. 7 is a view similar to FIG. 6 with the dispensing nozzle in a second position;

FIGS. 8 and 9 are side elevational views similar to FIG. 2 illustrating the dispensing nozzles adjusted for wear of the disc; and

FIG. 10 is a side elevational view of a further embodiment illustrating a pair of dispensing nozzles with a valve for directing the material to one or the other of the nozzles.

### DETAILED DESCRIPTION OF THE INVENTION

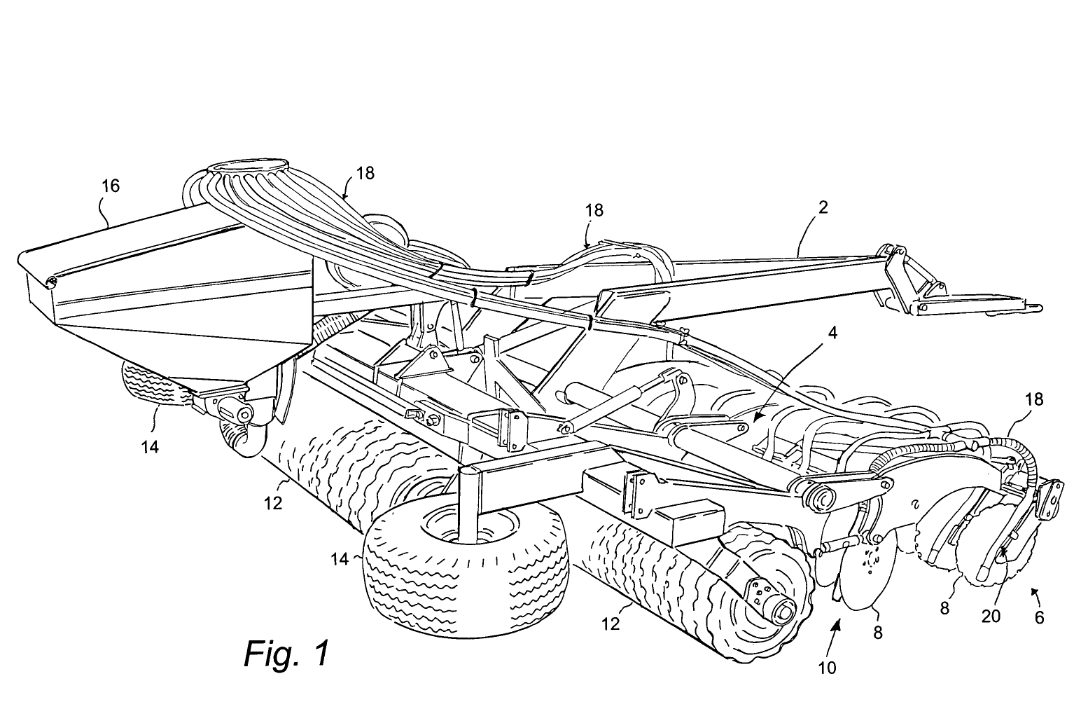

Referring now to the drawings, particularly to FIG. 1, there is illustrated an agricultural implement having a drawbar 2 for coupling to a tractor, not shown. The travel direction of the implement and tractor is from left to right in FIG. 1. The implement includes a frame 4, a first row 6 of spherical or conical cultivator discs 8, a second row 10 of discs, followed by three roller units 12, only two being shown in FIG. 1. Two support wheels 14 are also shown. The machine may be folded during transport in a way described in SE 0201794. A storage container 16 in the form of a hopper for material, e.g., granular material such as seed, fertilizer and the like is mounted to the frames 4.

A number of hoses 18 connect the hopper 16 with a number of material dispensers 20. Each dispenser 20 comprises a conduit 22, preferably metallic, such as a pipe, and an elastic dispensing nozzle 24, preferably formed of rubber. Each dispenser 20 is located close to a disc 8. A feed system, for example, a pneumatic feed system (known per se) provides for distribution of material from the hopper 16 to the dispensing nozzles 24.

The rotational axes 26 of the discs 8 are angularly displaced with respect to the transverse direction normal to the direction traveled and thereby efficiently create a furrow. This angle imposes side forces on the implement. Accordingly, the second row 10 of discs 8 is mirrored relative to the first row 6 to obtain equilibrium in the direction of travel.

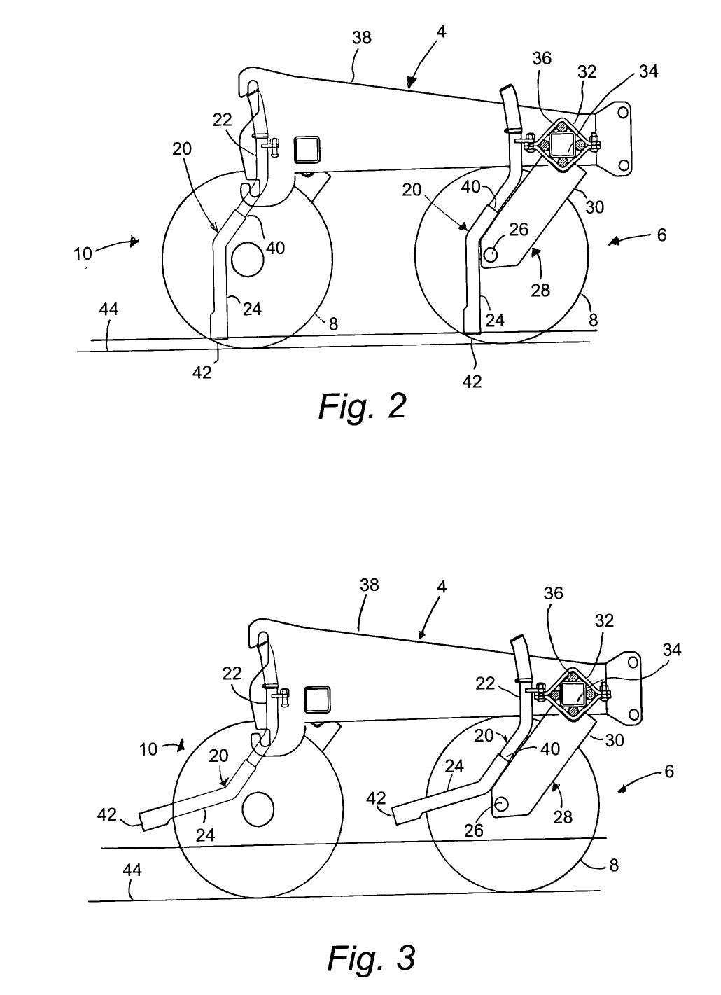

As illustrated in FIG. 2, each disc 8 is rotatably suspended by a suspension member 28. The suspension member 28 comprises an arm 30 and a bracket 32 which resiliently mounts to a frame member 34 in the form of a transverse square beam bounded by four rubber rods 36 whereby the suspension member 28 has limited resilient movement about the axis of the frame member 34. Each dispenser 20 comprises a metallic pipe 22, preferably fixed to the suspension member 28 but which may also be fixed to a frame member such as the longitudinal beam 38. The dispenser 20 may comprise a dispensing nozzle 24 with an inlet 40 rotatably and axially displaceable on the pipe 22. The dispensing nozzle has an outlet 42.

In FIG. 2, the dispensing nozzle 24 is in a first position with its outlet 42 at a first depositing location close to the lowest part of the disc 8 and slightly to the rear of the rotational axis 26 of disc 8. Thus, the dispensing nozzle in that depositing location deposits material at the bottom of a shallow furrow 44. In FIG. 3, however, the dispensing nozzle is in a second position, with the outlet 42 at a second depositing location behind the disc 8 at a height generally corresponding to the height of the rotational axis 26 relative to the soil. Consequently, it is possible to deposit material into or on top of the flow of soil created by the discs 8. In practice, the discs 8 on each row 6 and 10 will together create a fairly consolidated flow across the entire width of the implement.

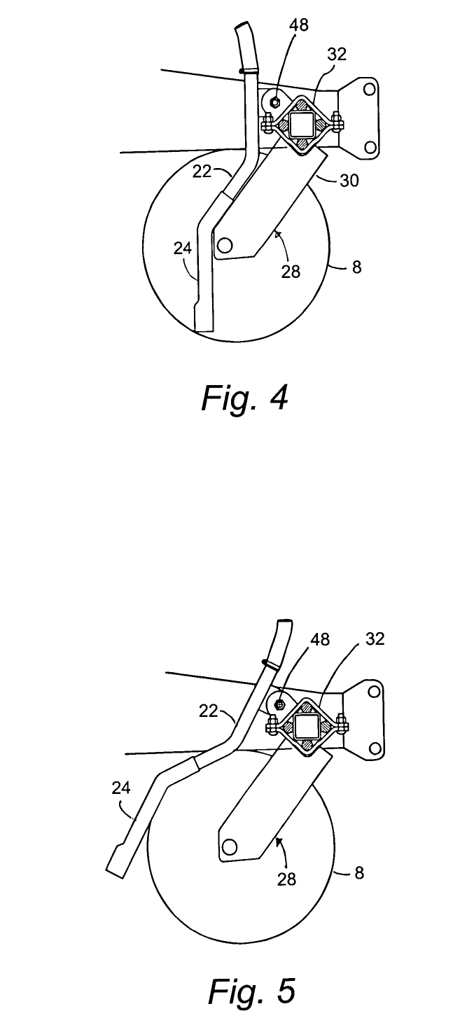

Referring to FIGS. 4 and 5, pipe 22 is pivotally connected to the bracket 32 of the suspension member 28 by a bolt 48. In FIG. 4, the dispensing nozzle 24 is in a first position, similar to that of FIG. 2. In FIG. 5, however, the dispensing nozzle lies in a second position equivalent to that of FIG. 3. The movement between the first and second positions is obtained by rotation of the pipe 22 and, hence, dispensing nozzle 24 about the bolt 48. As an alternative, pipe 22 may be pivotally connected to the arm 30 and which connection may also be resilient by using a rubber bushing or similar elastic material.

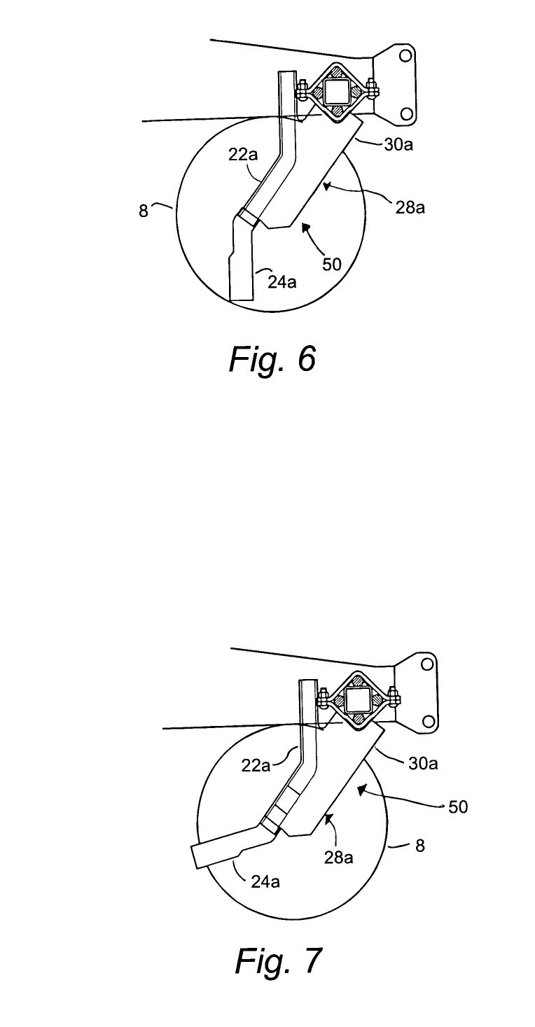

Referring now to FIGS. 6 and 7, wherein like reference numerals apply to like parts, succeeded by the letter “a,” the pipe 22a is manufactured as part of the piece 50, i.e., as part of the arm 30a of the suspension member 28a, preferably as one cast unit. In FIG. 6, the dispensing nozzle 24a lies in a first depositing position equivalent to FIG. 2. In FIG. 7, the dispensing nozzle 24a lies in a second depositing position equivalent to FIG. 3, achieved similarly as in the embodiment of FIGS. 2 and 3.

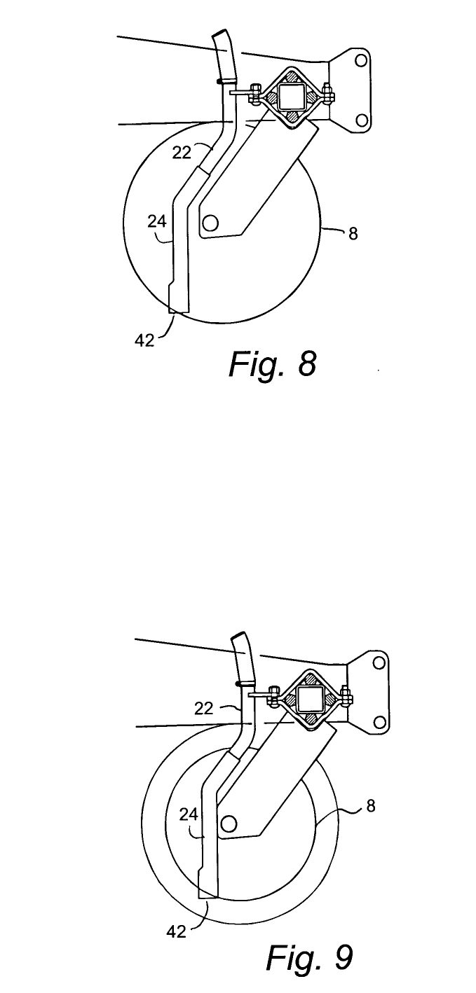

Referring to FIGS. 8 and 9, the dispensing nozzle 24 has been displaced axially on the pipe 22 such that the nozzle outlet 42 lies adjacent the rim of a disc 8, e.g., a new disc or a disc with only limited wear. In FIG. 9, the dispensing nozzle has been adjusted axially on pipe 22 to compensate for the wear on disc 8. In FIG. 9, the outer ring shows the unworn disc (similar to FIG. 8) and the inner ring shows a worn disc. The dispensing nozzle can also be displaced axially into its second position with the outlet 42 at the second depositing location.

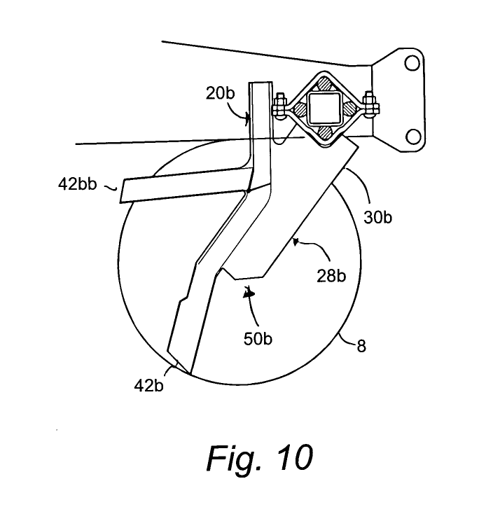

Finally, referring to FIG. 10, wherein like reference numerals are applied to like parts, followed by the letter “b”, the dispenser 20b may be manufactured integrally with piece 50b, i.e., as part of the arm 30b of the suspension member 28b. The dispenser 20b has two outlets 42b and 42bb. The first outlet 42b is located at a first depositing location close to the lowest part of the disc 8 slightly rearwardly of its rotational axis 26. The second outlet 42bb is located at a second depositing location behind the disc 8 at a height slightly above the rotational axis 26. A valve, for example, a flap 52, which may be manipulated by the operator, is used to switch the flow between the two depositing locations. Thus, the flap 52 may be pivoted into a first position, closing the dispensing nozzle having outlet 42bb and enabling flow of material through dispensing nozzle outlet 42b. Conversely, the flap may be pivoted into a position closing the dispensing nozzle terminating in outlet 42b and enabling flow of material through dispensing nozzle outlet 42bb. This embodiment may also be modified with an elastic dispensing nozzle with two outlets axially displaceable on a pipe, similarly as in FIGS. 8 and 9.

It will be appreciated that the implement of the present invention may be provided with additional soil preparation tools such as cultivator tines or harrows in front of the discs. The two rows of discs are also preferably laterally displaceable relative to each other. It will also be appreciated that there may be further intermediate depositing locations, although the two depositing locations are believed sufficient in most cases. While the design of the dispensers and their interaction with the discs may be varied in numerous ways, preferably the dispensers are connected to the support member arm, since it will then follow the movements of the discs and thereby assure deposit of the material in the furrow or into or on top of the soil flow. Further, the preferred axially and rotatably mounted rubber dispensing nozzles may be provided with locking or stop means in the depositing positions. It will also be appreciated that not all discs are required to have a dispenser associated with each disc. If a greater distance between crop rows is desired, only one of the disc rows may be equipped with the dispensers. Also, the outer discs may be arranged without dispensers since the soil flow at that location may be different.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An agricultural implement comprising:
a plurality of discs arranged to create furrows;
a plurality of dispensers for depositing material;
each dispenser being movable to provide at least first and second discrete depositing locations whereby only one location at a time may be used;
said first depositing location being at a location for depositing the material at the bottom of a furrow and the second depositing location being located for depositing the material into or on top of a soil flow created by one or more of said plurality of discs.

2. An implement according to claim 1 including two rows of conical or spherical discs located one row behind another with respect to the direction of travel of the machine, each row being arranged generally perpendicular to said direction of travel and at least one roller unit behind the discs with respect to said direction of travel.

3. An implement according to claim 2 wherein the number of dispensers is equal to the number of discs.

4. An implement according to claim 1 wherein each disc is rotatably arranged on an individual suspension member and resiliently suspended on a frame member, the rotational axes of the discs being angularly displaced with respect to a direction transverse to the direction of travel.

5. An implement according to claim 4 wherein each dispenser is fixed to said suspension member.

6. An implement according to claim 4 wherein each dispenser is pivotally or resiliently mounted to said suspension member.

7. An implement according to claim 4 wherein each dispenser is fixed, pivotally or resiliently mounted to a frame member.

8. An implement according to claim 1 wherein the dispenser comprises a conduit connected to a material container and a dispensing nozzle, the nozzle being mounted for axial displacement on said conduit.

9. An implement according to claim 8 wherein the conduit is made of a metallic material and the nozzle is formed of an elastic material.

10. An implement according to claim 1 wherein the dispenser has one outlet movable between the depositing locations.

11. An implement according to claim 10 wherein the dispenser comprises a nozzle rotatably mounted on a conduit, said nozzle being rotatable essentially through 180° between the first and second depositing locations.

12. An implement according to claim 1 wherein the first depositing location is located close to the lowest part of the disc and rearwardly of the rotational axis of the disc and the second depositing location is located at the same general height as said rotatable axis rearwardly of the first depositing location.
